(19) United States
(12) Patent Application Publication
(10) Pub. No.: US 2007/0081731 A1
(43) Pub. Date: Apr. 12, 2007

(54) Method of compressing moving pictures for mobile devices

(76) Inventor: Changho Lee, Sungnam city (KR)

Correspondence Address: Armstrong Kratz Quintos;Hanson & Brooks, Intellectual Property Law Offices, 502 Washington Avenue Suite 220, Townson, MD, 21204, US

(21) Appl. No.: 10/577,281

(22) PCT Filed: Nov. 24, 2004
(86) PCT No.: PCT/KR04/03048

§ 371 Date: Apr. 24, 2006

(30) Foreign Application Priority Data
Nov. 27, 2003 (KR) 1- 2003 0085157

(51) Int. Cl. G06K 9/36

(52) U.S. Cl. 382/236; 382/239

(57) ABSTRACT

Disclosed are technologies for compressing moving pictures. In particular, the present invention relates to a high efficient and simple method of compressing moving pictures for mobile devices. According to the method, it is possible to efficiently compress moving pictures because the method determines whether motion happened or not through a motion estimation process using macro blocks without obtaining motion vectors, and provides various choices in selecting size of blocks to be determined on whether motion happened or not. Further, the method performs P-frame coding based on previously existing P-frame as reference frame, so that the method may omit other previous P-frame and does not need any extra buffering, when transmitting moving pictures over networks. Thus, it has advantages of easy network support and great adaptability to data loss.

### TECHNICAL FIELD

The present invention relates to techniques of compressing moving pictures. More particularly, the present invention relates to a method of compressing moving pictures for mobile devices with high efficiency and no complexity.

### BACKGROUND ART

Efforts to effectively compress and store image data have been made continuously up to now. As a result, a lot of moving picture compressing technologies are used and there are a lot of international standards on moving picture compressing technology.

Moving Picture Expert Group Layer 1 (MPEG 1) is standards for storage media such as CD-ROM with transmission speed of 1.5 Mbps. A modified Discrete Cosine Transform (DCT) and motion compensation are combined for an image coding algorithm according to MPEG 1. Play functions comprise reverse play, high speed play, random access as well as forward play.

MPEG 2 is international standards for encoding and compression for digital TV broadcasting, communications, and color moving pictures and audio for storage media. MPEG 2 with transmission speed of 4˜100 Mbps provides much higher definition than MPEG 1 does.

MPEG 4 is international standards for encoding and compression of digital image and audio having transmission speed of less than 64 Kbps. Comparing with MPEG 1 or MPEG 2, MPEG 4 is standards for encoding and compression of image and video, having ultra low speed and high compressibility. MPEG 4 is used as solution for compressing moving pictures in wireless environments such as International Mobile Telecommunication (IMT)-2000. Bit rates according to MPEG 4 range from 30 Kbps to 1 Mbps.

H.261 is standards developed for video conference. H.261 has the same as performance of MPEG 1 and is used mainly for Integrated Services Digital Network (ISDN). Bit rate of H. 261 is equal to a multiplication of 64Kbps and a fixed number.

H. 263 is a codec which is a base of MPEG 4. H. 263 is developed for a video phone. And, H. 263 assumes that public telephone network is used, so that data bit rate of H. 263 is designated below 28.8 Kbps of V.34 modem.

H. 264 is a codec recently developed as standards for video phone, moving picture mobile handset and TV. H. 264 can improve compressibility as much as 2 times of MPEG 4.

FIG. 1 illustrates a related art method of compressing moving pictures according to MPEG. Intra-coding is explained first. When RGB image, object of compression, is inputted through means such as camera (S1), the RGB image is transformed into image in YUV420 format having both contrast information and color difference information (S2). After that transformation, the image is divided into macro blocks of 16 * 16 pixels and the macro blocks are further divided into blocks of 8 * 8 pixels. The blocks of 8 * 8 pixels are DCT transformed (S3) and then quantization process for DCT coefficients obtained through DCT transformation is performed (S4). Finally, the quantized DCT coefficient is entropy coded. The method of compressing moving pictures according to MPEG employs Huffinan coding using Huffman table as an entropy coding method (S5).

On the other hand, for inter-coding, motion estimation is performed first (S6). Motion vectors are obtained from blocks where motions happened, by using macro block of 16 * 16 pixels (S8). The motion vectors are entropy coded through Huffman coding (S10). Texture map information and texture blocks are obtained, in a case where it is impossible to obtain motion vectors. Texture coding is performed for texture blocks (i.e. blocks where motions happened and from which it is impossible to obtain motion vectors) (S9). DCT transformation (S11), quantization (S12) and Huffman coding (S13) are performed after the texture coding.

Up to now, recently developed CPU of 533 MHz has the best performance among CPUs used in mobile device. However, comparing with personal computer, the recently developed CPU used in mobile device still has drawbacks in performance, limited battery and memory. Thus, to compress moving pictures for mobile device, it is needed to introduce a method of compressing moving pictures that can reduce memory usage, display images rapidly without regard to performance of CPU, and have effective compressibility.

In general, images are expressed with 24 bits colors (R(red)-8bits, G(green)-8bits, B(blue)-8bits) and simple images such as graphic, animation and menu screen are also expressed with 24 bit colors.

However, there are a lot of simple still pictures that can be expressed with less than 256 colors. Thus, it is ineffective to express such simple still pictures with 256 colors indiscriminately.

Thus, it is necessary to employ a method of compressing still pictures for mobile devices that effectively compresses still pictures by reconstructing still pictures with appropriate number of colors depending on each still picture.

In addition, according to the related art method of coding moving pictures, motion vectors should be obtained from a search area based on macro block of 16 * 16 pixels, for motion estimation. The macro block of 16 * 16 pixels is not appropriate for mobile devices having small size of screen, so that quality of screen is worse when displaying images.

Thus, it is needed a method of compressing moving pictures for mobile devices that can compress still pictures by restructuring still pictures with the number of colors appropriate for each still picture, considering the number of pixels in screen of mobile devices and CPU capacity.

### DISCLOSURE OF INVENTION

In order to solve problems and subjects of the related art, there is provided a method of effectively compressing images for mobile communication image service.

According to a method of compressing moving pictures for mobile devices according to a preferred embodiment of the present invention, a process of inter-coding comprises: determining whether motion happened or not in pixel blocks of certain size, without obtaining motion vectors from the pixel blocks; indicating results of determining whether motion happened or not with a third map information value; and encoding motion blocks based on the third map information value.

Preferably, size of the pixel blocks may be freely chosen.

Preferably, the act of encoding motion blocks classifies the motion blocks into low bit motion blocks whose most sample values are low bit sample values and high bit motion blocks whose most sample values are high bit sample values, encodes the low bit motion blocks and the high bit motion blocks separately, and indicates results of classifying the motion blocks with a fourth map information value.

Preferably, the act of determining whether motion happened or not is performed for all pixel blocks of one frame continuously and the act of encoding motion blocks is performed for all pixel blocks of one frame continuously after the determination on whether motion happened or not. In other words, the present invention performs encoding of all pixel blocks of one frame after completing determination on whether motion happened or not for all pixel blocks of the frame, instead of determining whether motion happened or not in one pixel block and then encoding the determined pixel block.

Preferably, the process of inter-coding may further comprise encoding predicted frame (P-frame) based on previously existing intra frame (I-frame) as reference frame.

According to the present invention, for example, if frames comprise I frame, P1 frame, P2 frame and P3 frame, all the P1 frame, the P2 frame and the P3 frame are encoded based on the I frame as reference frame for inter-coding by encoding part thereof different from the I frame. This distinguishes the present invention from the related art method that encodes difference between the P2 frame and the P1 frame and difference between the P3 frame and the P2 frame.

Like above, the I frame, previously existing frame, is a reference frame for encoding the P frame, so that it is possible to regenerate frames without problems even when previous P frame is damaged. Thus, it is made possible to increase network transmission efficiency.

Intra-coding of the method of compressing moving pictures for mobile devices according to the present invention reconstructs still pictures with different number of colors per each still picture and comprises: checking (R, G, B) values of all pixels in the still pictures; arraying the (R, G, B) values in the order of frequency of existence and making as many (R, G, B) values as it is determined depending on each still picture representative (R, G, B) values; and designating index values for the representative (R, G, B) values and storing the representative (R, G, B) values as palette.

Preferably, the method of compressing still pictures for mobile devices according to the present invention further comprises: obtaining sample values and first map information values by using the index values; and classifying the sample values and compressing the sample values according to the classification.

Preferably, the sample values are generated and have the same value as current index value, in case that previous index value is different from the current index value.

Preferably, the first map information values indicate whether the index values change. Preferably, the sample values to be compressed are determined according to the first map information values.

Preferably, the act of classifying the sample values and compressing the sample values according to the classification classifies the sample values into low bit sample values and high bit sample values, the low bit sample values being able to be expressed with less than certain number of bits, the high bit sample values being unable to be expressed with the certain number of bits, and wherein the low bit sample values and the high bit sample values are separately compressed.

Preferably, whether the sample values can be expressed with less than certain number of bits is indicated by second map information values.

### BRIEF DESCRIPTION OF THE DRAWINGS

FIG. 1 illustrates a related art method of compressing moving pictures according to MPEG.

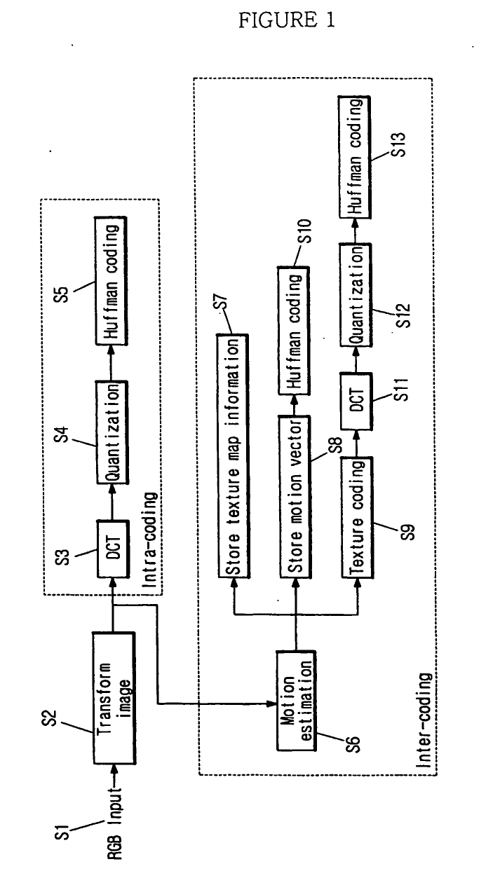

FIG. 2 illustrates a method of compressing moving pictures for mobile devices according to the present invention.

### BEST MODE FOR CARRYING OUT THE INVENTION

Hereinafter, a detailed description on a method of compressing moving pictures for mobile devices will be made with reference to the attached drawings.

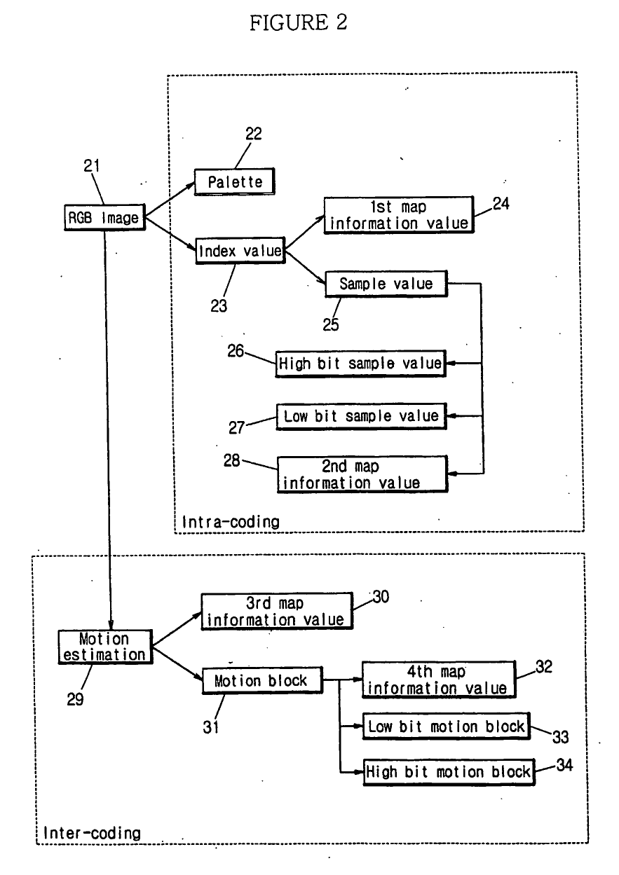

FIG. 2 illustrates a method of compressing moving pictures for mobile devices according to the present invention.

A method of compressing moving pictures for mobile devices of the present invention comprise an intra-coding process that still pictures are reconstructed with as many colors as it is determined depending on each still picture, object of compression, and that the reconstructed still pictures are compressed.

For reconstruction of the still pictures, (R, G, B) values of all pixels in the still pictures are checked and arrayed in the order of frequency of existence (e.g. refer to following table 1).

TABLE 1

| R, G, B value | Frequency of existence |
|---|---|
| (100, 110, 120) | 100 |
| (110, 120, 130) | 90 |
| (120, 130, 140) | 80 |
| (130, 140, 150) | 70 |
| (140, 150, 160) | 60 |
| . . . | . . . |

Then, as many (R, G, B) values as it is predetermined for reconstruction of the still pictures are arrayed. For example, to reconstruct still pictures having (R, G, B) values arrangement like the Table 1 with 128 colors, 128 (R, G, B) values from the most frequent (R, G, B) value (100, 110, 120) are arranged. Index value 23 and palette 22 are determined using the 128 (R, G, B) values. For example, index value and palette are determined like following Table 2.

TABLE 2

| Index value | Palette |
|---|---|
| 0 | (100, 110, 120) |
| 1 | (110, 120, 130) |
| 2 | (120, 130, 140) |
| 3 | (130, 140, 150) |
| . . . | . . . |
| 127 | (200, 150, 100) |

The palette 22 consists of representative (R, G, B) values extracted from (R, G, B) values of the still pictures. The index values 23 become index of each (R, G, B) value forming the palette 22. Through the above processes, pixels can be expressed with the index values 23 replacing the (R, G, B) values, and palette 22 corresponding to the index values is constructed. The palette 22 is stored as it is to be used as color information of still pictures to be decompressed when decoding is performed.

On the other hand, RGB images that are compressed to be used as still pictures for mobile devices are almost simple still pictures and it is general that simple still pictures consists of pixels of same data values continuously, so that it is possible to compress still pictures more effectively. This can be utilized in a process of obtaining sample values 25 and first map information values 24 from the index values 23. The sample values 25 are generated when current index value is different from previous index value, and have the same values as the current index values. The first map information values 24 indicate whether the current index value is identical with the previous index value after comparing the current index value and the previous index value. The first map information values 24 can be expressed by using 1 bit. For example, the first map information value 24 can be designated as “1” in a case where the current index value is identical with the previous index value, otherwise the first map information value 24 can be designated as “0”. Conversely, the first map information values 24 can be designated as “0” in a case where the current index value is identical with the previous index value, otherwise the first map information value 24 is designated as “1”.

After obtaining the sample values 25 and the first map information values 24 from the index values 23, the sample values 25 are classified into low bit sample values 27 and high bit sample values 26 to be compressed effectively. Sample values that can be expressed by using less than certain number of bits are designated as “low bit sample values” and sample values that requires more than the certain number of bits are designated as “high bit sample values.” At this time, the low bit sample values and the high bit sample values are separately arrayed and compressed. Further, second map information values 28 are designated and used to indicate whether the sample values are the low bit sample values 27 or the high bit sample values 26. The second map information values 28 are used for effective performance of compression and decompression.

TABLE 3

| | | | | | | | | | | | | |
|---|---|---|---|---|---|---|---|---|---|---|---|---|
| Index value | 2 | 2 | 2 | 2 | 2 | 10 | 10 | 10 | 1 | 15 | 15 | 15 |
| First map | 1 | 0 | 0 | 0 | 0 | 1 | 0 | 0 | 1 | 1 | 0 | 0 |
| Information | | | | | | | | | | | | |
| value | | | | | | | | | | | | |
| Sample value | 2 | | | | | 10 | | | 1 | 15 | | |
| Low bit | 2 | | | | | | | | 1 | | | |
| sample value | | | | | | | | | | | | |
| High bit | | | | | | 10 | | | | 15 | | |
| sample value | | | | | | | | | | | | |
| Second map | 0 | | | | | 1 | | | 0 | 1 | | |
| Information | | | | | | | | | | | | |
| value | | | | | | | | | | | | |

The Table 3 gives examples of first map information values, sample values, low bit sample values, high bit sample values and second map information values depending on change on index values. In the Table 3, sample values that can be expressed by using less than 2 bits are designated as low bit sample values and sample values that can not be 5 expressed by using 2 bits are designated as high bit sample values. The second map information value for low bit sample values is designated as “0” and the second map information value for high bit sample values is designated as “1”. Specific second map information values for low bit sample values and high bit sample values can be freely designated. Thus, conversely, the second map information value for low bit sample values can be designated as “1” and the second map information value for high bit sample values can be designated as “0”.

As described above, sample values are classified, depending on whether sample values can be expressed by using less than certain number of bits, into high bit sample values and low bit sample values. Then, according to the classification, high bit sample values and low bit sample values are separately compressed.

For example, let us suppose that sample values that can be expressed by using less than 2 bits are low bit sample values and sample values that can not be expressed by using 2 bits are high bit sample values. In this case, 4 low bit sample values can be expressed by using 1 byte. However, just 2 or 3 high bit sample values can be expressed by using 1 byte. Sometimes, 2 bytes are needed to express 3 high bit sample values.

According to a method of compressing moving pictures for mobile devices of the present invention, motion estimation can be performed for certain size of pixel blocks (e.g. pixel blocks of 4 * 4 pixels). Size of the pixel blocks is not limited and is changeable.

The changeable size of pixel blocks distinguishes the present invention from the related art method of compressing moving pictures that performs motion estimation based on a macro block due to DCT transform.

Further, the method according to the present invention only determines whether motion happened, without obtaining motion vectors from the pixel blocks, and indicates results of the determination with a third map information value 30. At this time, whether motion happened or not is checked for pixel blocks of same position. The third map 10 information values can be expressed with “0” and “1.” The third map information value can be designated as “0” for pixel blocks where motions happened, otherwise the third map information value can be designated as “1.” Conversely, the third map information value can be designated as “1” for pixel blocks where motions happened, otherwise the third map information value can be designated as “0.” Further, the third map information value can 15 be stored with a unit of 1 byte because it is effective to store the third map information value with a unit of 1 byte for rapid restoration.

Hereinafter, the pixel blocks where motions happened will be termed as motion block. A process of encoding the motion block is not significantly different from a process of coding still pictures. According to the process of encoding the motion block, sample values of the motion blocks are obtained, and whether the sample values can be expressed with less than 2 bits or not is determined. Then, the sample values are classified into low bit sample value in a case where the sample value can be expressed with less than 2 bits, and into high bit sample value in a case where the sample value can not be expressed with less than 2 bits.

Also, the motion blocks are classified into low bit motion block in a case most sample values of the motion blocks are low bit sample values and, into high bit motion block in a case most sample values of the motion blocks are high bit sample values.

At this time, the low bit motion blocks 33 and high bit motion blocks 34 can be indicated with a fourth map information values 32. For example, the fourth map information value can be designated as “0” in a case of low bit motion blocks and the fourth map information value can be designated as “1” in a case of high bit motion blocks.

According to the method of compressing moving pictures for mobile devices, for encoding one frame, motion estimation is performed continuously for all pixel blocks of the frame, and a process of encoding the frame is performed for all pixel blocks of the frame all at once after performing the motion estimation. It is made possible to perform inter-coding efficiently with the third map information value and the fourth map information value. The third map information value distinguishes motion blocks from pixel blocks where no motion happened. The fourth map information value distinguishes the low bit motion blocks whose most motion blocks are low bit sample values from the high bit motion blocks whose most motion blocks are high bit sample values.

In other words, it is made possible to efficiently encode one frame by arranging and encoding high bit motion blocks and low bit motion blocks separately.

### INDUSTRIAL APPLICABILITY

The method of compressing moving pictures for mobile devices according to the present invention only determines whether motion happened or not, without obtaining motion vectors through a process of motion estimation using macro blocks, and freely chooses size of pixel blocks to be determined on whether motion happened or not, thereby effectively compressing moving pictures.

Further, according to the method of compressing moving pictures for mobile devices, encoding of predicted frame (P-frame) is performed based on previously existing intra frame (I-frame), so that it is possible to omit other previous P-frame when transmitting moving pictures over network, and it does not need extra buffering. Thus, it has advantages of easy network support and great adaptability to data loss.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of compressing moving pictures for mobile devices, wherein a process of inter-coding comprises:
determining whether motion happened or not in pixel blocks of certain size, without obtaining motion vectors from the pixel blocks;
indicating results of determining whether motion happened or not with a third map information value; and
encoding motion blocks based on the third map information value.

2. The method of claim 1, wherein size of the pixel blocks are freely chosen.

3. The method of claim 1, wherein the act of encoding motion blocks classifies the motion blocks into low bit motion blocks whose most sample values are low bit sample values and high bit motion blocks whose most sample values are high bit sample values, encodes the low bit motion blocks and the high bit motion blocks separately, and indicates results of classifying the motion blocks with a fourth map information value.

4. The method of claim 1, wherein the act of determining whether motion happened or not is performed for all pixel blocks of one frame continuously and the act of encoding motion blocks is performed for all pixel blocks of one frame continuously after the determination on whether motion happened or not.

5. The method of claim 1, wherein the process of inter-coding further comprises encoding predicted frame (P-frame) based on previously existing intra frame (I-frame) as reference frame.
